(19) United States
(12) Patent Application Publication
(10) Pub. No.: US 2015/0338429 A1
(43) Pub. Date: Nov. 26, 2015

(54) ANALYSIS UNIT FOR ANALYSIS DEVICE

(71) Applicant: IMMUNODIAGNOSTIC SYSTEMS FRANCE, Pouilly en Auxois (FR)

(72) Inventors: Alain ROUSSEAU, Paris (FR); Olivier LERAT, Agey (FR); Norbert BRUTT, Beurey Bauguay (FR)

(73) Assignee: IMMUNODIAGNOSTIC SYSTEMS FRANCE, Pouilly en Auxois (FR)

(21) Appl. No.: 14/759,191

(22) PCT Filed: Jan. 3, 2014
(86) PCT No.: PCT/FR2014/050003

§ 371 Date: Jul. 2, 2015

(30) Foreign Application Priority Data
Jan. 4, 2013 (FR) 13/50046

(51) Int. Cl. G01N 35/10; G01N 1/38

(52) U.S. Cl. CPC G01N 35/10; G01N 1/38; G01N 2035/00524

(57) ABSTRACT

This analysis unit (2) comprises a rack (11) suitable for receiving at least a first and a second container (3a, 3b), and an agitating device (22) suitable for mounting on the rack (11), the agitating device (22) being designed to drive at least the first container (3a) in rotation when the agitating device cooperates with a drive unit of an analysis device. The agitating device (22) comprises coupling means designed to rotationally couple at least the first and second containers (3a, 3b) held on the rack (11), the coupling means being configured to drive at least the second container (3b) in rotation when the first container (3a) is driven in rotation by the agitating device.

### TECHNICAL FIELD

The present invention concerns an analysis set for an analysis apparatus, and more particularly for an analysis apparatus for in vitro diagnosis.

### BACKGROUND

The document EP 2 043 786 describes an analysis set intended to be used in an analysis apparatus for in vitro diagnosis, comprising:
a container of a first type containing a solution including magnetic particles intended to capture an analyte to be detected and/or assayed,
a cartridge including several containers of a second type assembled together, each container of the second type containing a liquid reactive product,
a carrier intended to receive the cartridge, and
a stirring device comprising a receiving member movably mounted in rotation on the carrier and delimiting a receiving housing intended to receive the container of the first type, the receiving member presenting on its outer surface a coupling toothing intended to cooperate with a driving unit of the analysis apparatus to rotatably drive, when in use, the container of the first type received in the receiving housing of the receiving member.

Such an analysis set allows to ensure stirring of the solution contained in the container of the first type, and thus to avoid agglutination and sedimentation of the magnetic particles contained in this solution which may be detrimental to the subsequent analyses that are carried out from said solution.

Some analyses require carrying out consecutively different biological separations in order to assay and/or detect a particular analyte. Such analyses require then the successive use of different magnetic particles, and therefore the insertion, in the analysis apparatus, of several analysis sets comprising containers of the first type which contain solutions based on different magnetic particles.

Furthermore, since the analyses to be performed are diverse and varied, it may be necessary to provide a very significant number of analysis sets in an analysis apparatus in order to ensure the availability of the different magnetic particles that are essential for carrying out these analyses.

Since the storage capacity of an analysis apparatus is reduced, it is necessary to regularly replace the different analysis sets with other analysis sets within the same day, which is detrimental to the efficiency of the analysis apparatus.

### BRIEF SUMMARY

The present invention aims to overcome these drawbacks.

Hence, the technical problem that underlies the invention comprises providing an analysis set which is simple in structure and economical, while allowing to improve the efficiency of an analysis apparatus receiving said analysis set.

To this end, the present invention concerns an analysis set for an analysis apparatus, comprising:
a carrier intended to be removably inserted in the analysis apparatus, and more particularly in a storage area of the analysis apparatus, the carrier being adapted to receive at least one first container of a first type intended to contain a reactive product, the carrier comprising:

a storage housing intended to receive a plurality of stationary containers of a second type each equipped with a neck equipped with a closing device, and

position holding means arranged to cooperate with the necks of the stationary containers when the stationary containers are received in the storage housing,
a stirring device adapted to be mounted on the carrier and intended to cooperate with a driving unit of an analysis apparatus, the stirring device being arranged to rotatably drive at least the first container of the first type when said first container is received on the carrier and when the stirring device cooperates with the driving unit of the analysis apparatus,

characterized in that the carrier is adapted to receive at least a second container of the first type, and in that the stirring device comprises coupling means arranged to rotatably couple at least the first and second containers of the first type when said first and second containers are received on the carrier, the coupling means being shaped to rotatably drive at least the second container when the first container is rotatably driven, for example by means of the driving unit of the analysis apparatus.

Such a configuration of the analysis set according to the invention allows to ensure storage on the carrier of at least two containers of the first type containing solutions including magnetic particles, and easy stirring of these two containers from the same driving unit of the analysis apparatus.

Thus, the analysis set according to the invention allows, for example, the storage on the carrier of two containers containing the same solution based on magnetic particles, thereby allowing to increase the number of identical tests that may be carried out using the same analysis set.

The analysis set according to the invention also allows, for example, the storage on the carrier of two containers containing solutions based on different magnetic particles, thereby allowing to carry out different tests using the same analysis set.

Consequently, the analysis set according to the invention allows to carry out a significant number of tests with a reduced number of analysis sets, thereby allowing to improve the capacity and efficiency of an analysis apparatus, and thus to decrease the costs that are associated to each test.

According to an embodiment of the invention, the stirring device comprises at least one first and one second receiving members movably mounted in rotation on the carrier and shaped to house, when in use, respectively the first and second containers, the coupling means being arranged to rotatably couple the first and second receiving members. According to an embodiment of the invention, the stirring device comprises a plurality of receiving members.

According to an embodiment of the invention, each of the first and second receiving members, and preferably each receiving member, delimits a receiving housing in which the corresponding container is intended to be housed, at least in part.

According to an embodiment of the invention, each of the first and second receiving members includes a receiving portion delimiting the corresponding receiving housing, the receiving portion of each of the first and second receiving members being substantially cylindrical, and extending at least in part in a through passageway with a complementary shape and arranged on the carrier.

According to an embodiment of the invention, each of the first and second receiving members further comprises a mounting portion substantially cylindrical and extending coaxially with respect to, and preferably from, the corresponding receiving portion, the mounting portion of each of the first and second receiving members being mounted in free rotation in a bore arranged on the carrier and opening opposite the through passageway in which the corresponding receiving portion is mounted.

According to an embodiment of the invention, the first receiving member, that is to say the receiving member that is shaped to house the first container, is intended to cooperate with and to be rotatably driven by the driving unit of the analysis apparatus.

According to an embodiment of the invention, each of the first and second receiving members includes on its outer surface a coupling toothing, the coupling toothings of the first and second receiving members forming at least in part the coupling means. According to an embodiment of the invention, each receiving member includes on its outer surface a coupling toothing, the coupling toothings of the receiving members forming at least in part the coupling means.

According to an embodiment of the invention, the coupling means include at least one coupling member movably mounted in rotation on the carrier and arranged to rotatably couple the coupling toothings of the first and second receiving members. According to an embodiment of the invention, the coupling means include a plurality of coupling members movably mounted in rotation on the carrier and each arranged to rotatably couple the coupling toothings of two adjacent receiving members.

According to an embodiment of the invention, each of the first and second receiving members, and preferably each receiving member, comprises immobilization means arranged to rotatably immobilize, when in use, the corresponding container housed in said receiving member.

The immobilization means of each of the first and second receiving members include for example at least one immobilization rib intended to cooperate with a complementary immobilization groove arranged on the outer wall of the corresponding container.

According to an embodiment of the invention, at least one of the first and second receiving members comprises translation blocking means arranged to block in translation said receiving member relative to the carrier. Advantageously, the mounting portion of each of the first and second receiving members comprises at least one snap-fit element arranged to cooperate with the carrier to block in translation said receiving member relative to the carrier.

The position holding means comprise for example a plurality of notches each intended to cooperate with the neck of a stationary container received in the storage housing. Advantageously, each of the notches extends substantially perpendicular to the axes of rotation of the receiving members.

According to an embodiment of the invention, the analysis set comprises the first and second containers of the first type.

According to an embodiment of the invention, the analysis set comprises a plurality of second containers of the first type, and the coupling means are arranged to rotatably couple the first container of the first type and the plurality of second containers of the first type when said first and second containers are received on the carrier, the coupling means being shaped to rotatably drive the plurality of second containers of the first type when the first container of the first type is rotatably driven.

According to an embodiment of the invention, each of the first and second containers contains a solution including magnetic particles intended to capture an analyte to be detected and/or assayed.

According to an embodiment of the invention, the analysis set further comprises a plurality of stationary containers intended to be received in the storage housing of the carrier and each being intended to contain a liquid reactive product.

According to a variant of the invention, the coupling means may be arranged in part directly on the first and second containers. Thus, each of the first and second containers may comprise a coupling toothing capable of cooperating directly together or via a coupling member movably mounted in rotation on the carrier.

According to an embodiment of the invention, each of the first and second containers of the first type includes a body and a neck made of a synthetic material, for example by blow molding.

According to an embodiment of the invention, the neck of each container of the first type is equipped with a closing plug which may for example be provided with a puncturable wall.

According to an embodiment of the invention, the body of each container of the first type is substantially cylindrical, and the body of each container of the second type is substantially parallelepiped-shaped.

According to an embodiment of the invention, the carrier comprises at least three preferably aligned receiving members.

### BRIEF DESCRIPTION OF THE DRAWINGS

Anyway, the invention will be better understood in light of the following description with reference to the appended schematic drawing representing, as non-limiting examples, two embodiments of this analysis set.

FIG. 1 is a perspective view of an analysis set according to a first embodiment of the invention.

FIG. 2 is a partial exploded perspective view of the analysis set of FIG. 1.

FIG. 3 a perspective view of an analysis set according to a second embodiment of the invention.

### DETAILED DESCRIPTION

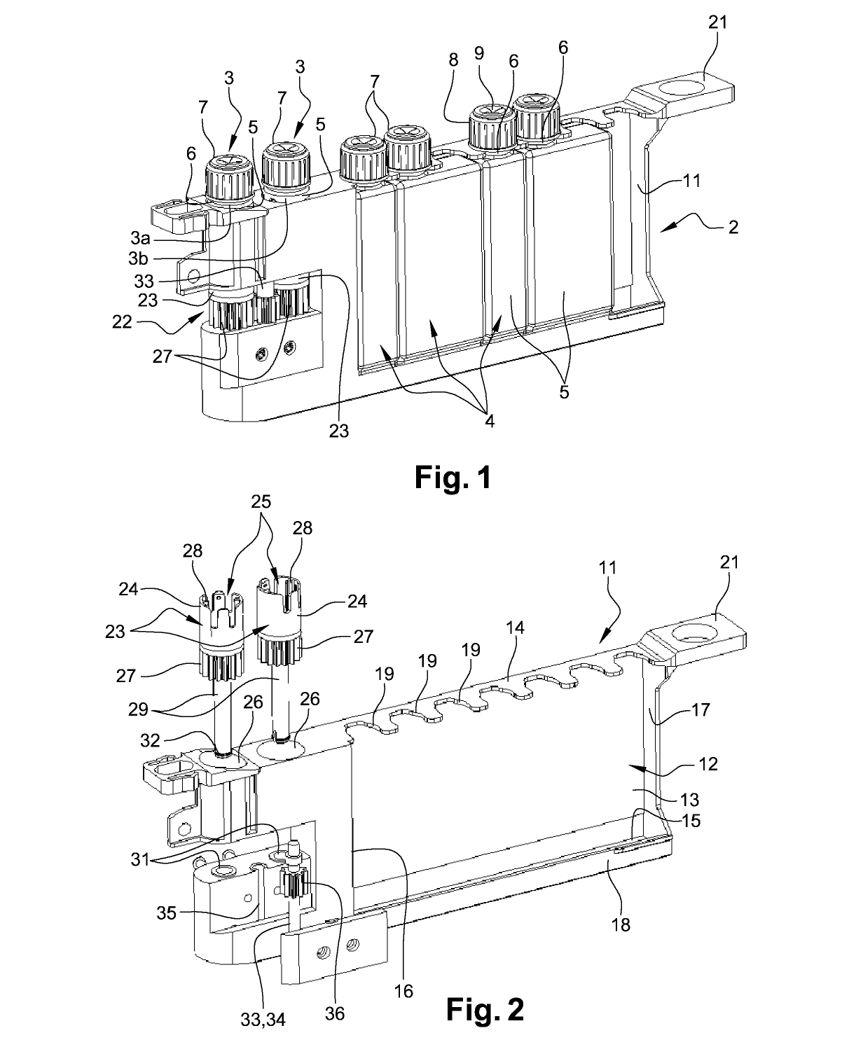

FIGS. 1 and 2 represent an analysis set 2 intended to be used in an analysis apparatus for in vitro diagnosis.

The analysis set 2 comprises a plurality of containers 3 of a first type each containing a solution including magnetic particles intended to capture an analyte to be analyzed, and a plurality of containers 4 of a second type each containing a liquid reactive product. According to the embodiment represented in FIGS. 1 and 2, the analysis set 2 comprises more particularly first and second containers 3a, 3b of the first type.

Each container 3, 4 includes a body 5 and a neck 6 made of a synthetic material, for example by blow molding. The body 5 of each container 3 of the first type is substantially cylindrical, whereas the body 5 of each container 4 of the second type is substantially parallelepiped-shaped. It should be noted that the containers 4 of the second type may be of different sizes, and therefore of different capacities.

The neck 6 of each container 3, 4 is equipped with a closing plug 7 comprising a skirt 8 which presents, on its inner face, screwing or snap-fitting fastening means arranged to cooperate with complementary fastening means provided on said neck 6, and a puncturable end wall 9. The end wall 9 comprises, for example, several slots which enable easy insertion or retrieval of a probe or a needle of the analysis apparatus in the corresponding container.

Advantageously, the containers 3 of the first type include longitudinal fins arranged on their inner wall.

The containers 4 of the second type may for example be fastened to each other by means of a self-adhesive label so as to form a cartridge. The self-adhesive label may optionally include, on its outer face, a bar code enclosing indications with regards to the cartridge, in particular for example the identification of the reactive products that are used and the analysis to be performed.

As is more particularly shown in FIG. 2, the analysis set 2 also comprises a carrier 11 made for example of a synthetic material.

The carrier 11 includes a storage housing 12 intended to receive a plurality of containers 4 of the second type. The storage housing 12 is delimited by a bottom wall 13, a lower and an upper walls 14, 15 which are substantially parallel and each extending substantially perpendicular to the bottom wall 13, two lateral walls 16, 17 which are substantially parallel and each extending substantially perpendicular to the bottom wall 13, and finally an edge 18 extending substantially perpendicularly from the lower wall 15.

The carrier 11 also includes position holding means arranged to cooperate with the necks 6 of the containers 4 when these are received in the storage housing 12. The position holding means advantageously comprise a plurality of holding notches 19 arranged on the upper wall 14 and evenly distributed along the length of the latter. Each holding notch 19 is intended to cooperate with the neck 6 of a container 4 received in the storage housing 12 so as to immobilize said container 4 relative to the carrier 11. The holding notches 19 extend in a plane substantially perpendicular to the axis of the necks 6 of the containers 4 when these are fastened on the carrier 11.

In order to ensure an optimum fastening of the containers 4 on the carrier 11, each holding notch 19 presents a shape which is complementary at least in part with the shape of the neck 6 of each container 4, and the distance between the upper and lower walls 14, 15 corresponds substantially to the height of the bodies 6 of the containers 4.

In order to fasten the containers 4 on the carrier 11, it suffices to firstly engage the basis of each container 4 between the edge 18 and the bottom wall 13, then to engage the neck 6 of each container 4 in the respective holding notch 19.

The carrier 11 also includes a holding handle 21 for facilitating the handling of the carrier 11, and in particular the insertion and the retrieval of the analysis set 2 in and out of an analysis apparatus.

The analysis set 2 further comprises a stirring device 22 mounted on the carrier 11. The stirring device 22 comprises a plurality of receiving members 23 movably mounted in rotation on the carrier 11. According to the embodiment represented in FIGS. 1 and 2, the stirring device 22 comprises two receiving members 23.

Each receiving member 23 includes a receiving portion 24 delimiting a receiving housing 25 in which a container 3 of the first type is intended to be housed, at least in part. The receiving portion 24 of each receiving member 23 is substantially cylindrical, and extends at least in part in a through passageway 26 with a complementary shape and arranged on the carrier 11. The receiving portion 24 of each receiving member 23 comprises, on its outer surface, a coupling toothing 27 which is annular and coaxial with the axis of rotation of said receiving member 23. The receiving portion 24 of each receiving member 23 further comprises, on its inner surface, at least one immobilization rib 28 intended to cooperate with a complementary immobilization groove arranged on the outer wall of the corresponding container 3, to rotatably immobilize said container 3 relative to the corresponding receiving member 23.

Each receiving member 23 also comprises a cylindrical mounting portion 29 extending coaxially from the corresponding receiving portion 24. The mounting portion 29 of each receiving member 23 is mounted in free rotation in a bore 31 arranged on the carrier 11 and opening opposite the through passageway 26 in which the corresponding receiving portion 24 is mounted.

It should be noted that the mounting portion 29 of each receiving member 23 comprises, at its free end, at least one snap-fit element 32 arranged to cooperate with the carrier 11 to block in translation the corresponding receiving member 23 relative to the carrier 11.

The stirring device 22 further includes a coupling member 33 movably mounted in rotation on the carrier 11 and arranged to rotatably couple the coupling toothings 27 of the receiving members 23. The coupling member 33 comprises a mounting portion 34 movably mounted in rotation in a bore 35 arranged on the carrier 11, and a coupling pinion 36 secured to the mounting portion 34 and meshing with the coupling toothings 27 of the receiving members 23.

The coupling toothings 27 and the coupling member 33 are arranged to rotatably couple the two receiving members 23, and are shaped to rotatably drive the two receiving members 23, and therefore the containers 3 that are received in the receiving members 23, when one of the receiving members 23 is rotatably driven by a driving unit of an analysis apparatus. Advantageously, the coupling toothing 27 of the receiving member 23 opposite to the storage housing 12, that is to say intended to house the container 3a, is arranged to cooperate with the driving unit of an analysis apparatus. The driving unit of the analysis apparatus may for example be formed of a rack or a gear wheel arranged to cooperate with the coupling toothing 27 of the receiving member 23 opposite to the storage housing 12.

Preferably, the stirring device 22 is shaped to rotatably drive the containers 3 of the first type alternately in a first direction and in a second direction opposite to the first direction.

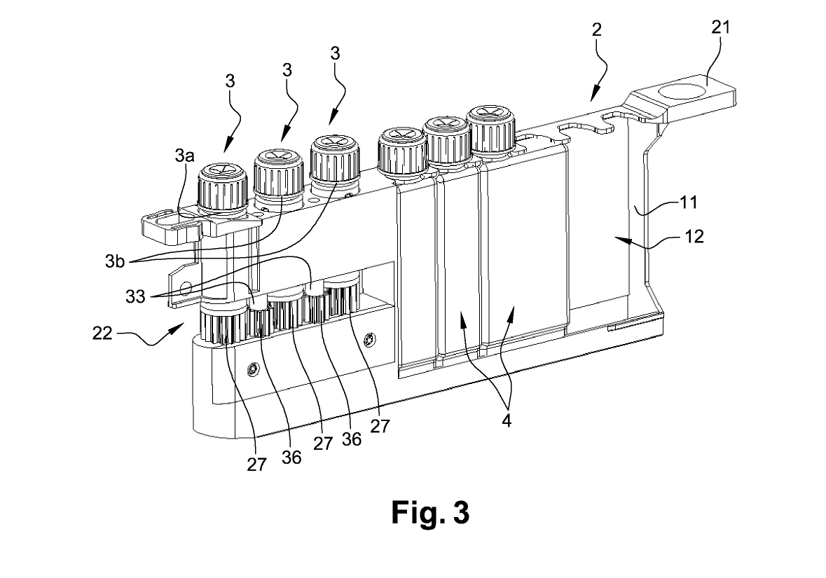

FIG. 3 represents an analysis set 2 according to a second embodiment of the invention which differs from the embodiment represented in FIGS. 1 and 2, mainly in that the analysis set includes three containers 3 of the first type, three aligned receiving members 23 and two coupling members 33 each arranged to rotatably couple two adjacent receiving members 23.

According to a variant of the invention not represented in the figures, the analysis set 2 may be devoid of coupling members 33, and the coupling toothing 27 of a receiving member 23 may directly mesh with the coupling toothing 27 of an adjacent receiving member 23.

It goes without saying that the invention is not limited to the sole embodiments of this analysis set, described above as examples, but it encompasses, on the contrary, all variants thereof.

1. An analysis set for an analysis apparatus, comprising:
a carrier intended to be inserted in the analysis apparatus, the carrier being adapted to receive at least one first container of a first type, the carrier comprising:
a storage housing intended to receive a plurality of stationary containers of a second type each provided with a neck equipped with a closing device, and
position holding means arranged to cooperate with the necks of the stationary containers when the stationary containers are received in the storage housing,
a stirring device adapted to be mounted on the carrier and intended to cooperate with a driving unit of an analysis apparatus, the stirring device being arranged to rotatably drive at least the first container of the first type when said first container is received on the carrier and when the stirring device cooperates with the driving unit of the analysis apparatus,
wherein the carrier is adapted to receive at least a second container of the first type, and the stirring device comprises coupling means arranged to rotatably couple at least the first and second containers of the first type when said first and second containers are received on the carrier, the coupling means being shaped to rotatably drive at least the second container when the first container is rotatably driven.

2. The analysis set according to claim 1, wherein the stirring device comprises at least one first and one second receiving members movably mounted in rotation on the carrier and shaped to house, in use, respectively the first and second containers, the coupling means being arranged to rotatably couple the first and second receiving members.

3. The analysis set according to claim 2, wherein each of the first and second receiving members delimits a receiving housing in which the corresponding container is intended to be housed, at least in part.

4. The analysis set according to claim 2, wherein each of the first and second receiving members includes a receiving portion PO delimiting the corresponding receiving housing, the receiving portion of each of the first and second receiving members being substantially cylindrical, and extending at least in part in a through passageway with a complementary shape and arranged on the carrier.

5. The analysis set according to claim 4, wherein each of the first and second receiving members further comprises a mounting portion substantially cylindrical and extending coaxially with respect to the corresponding receiving portion, the mounting portion of each of the first and second receiving members being movably mounted in rotation in a bore arranged on the carrier and opening opposite the through passageway in which the corresponding receiving portion is mounted.

6. The analysis set according to claim 25, wherein the first receiving member is intended to cooperate with and to be rotatably driven by the driving unit of the analysis apparatus.

7. The analysis set according to claim 2, wherein each of the first and second receiving members includes on its outer surface a coupling toothing, the coupling toothings of the first and second receiving members forming at least in part the coupling means.

8. The analysis set according to claim 7, wherein the coupling means include at least one coupling member (33) movably mounted in rotation on the carrier (11) and arranged to rotatably couple the coupling toothings (27) of the first and second receiving members (23).

9. The analysis set according to claim 2, wherein each of the first and second receiving members comprises immobilization means arranged to rotatably immobilize, in use, the corresponding container housed in said receiving member.

10. The analysis set according to claim 9, wherein the immobilization means of each of the first and second receiving members include at least one immobilization rib intended to cooperate with a complementary immobilization groove arranged on the outer wall of the corresponding container.

11. The analysis set according to claim 2, wherein at least one of the first and second receiving members comprises translation blocking means arranged to block in translation said receiving member relative to the carrier.

12. The analysis set according to claim 1, wherein the position holding means comprise a plurality of notches each intended to cooperate with the neck of a stationary container received in the storage housing.

13. The analysis set according to claim 12, wherein each of the notches extends substantially perpendicular to the axes of rotation of the receiving members.

14. The analysis set according to claim 1, wherein the carrier includes a holding handle shaped to enable insertion and retrieval of the carrier in and out of the analysis apparatus.
